(19) United States
(12) Patent Application Publication
(10) Pub. No.: US 2008/0137642 A1
(43) Pub. Date: Jun. 12, 2008

(54) MOBILE DEVICE CALL TO COMPUTING DEVICE

(75) Inventors: Dan Teodosiu, Dublin (IE); Xiaoyong Liu, Kirkland, WA (US); Lon-Chan Chu, Redmond, WA (US); Vinay Gupta, Sammamish, WA (US)

Correspondence Address: VIERRA MAGEN/MICROSOFT CORPORATION, 575 MARKET STREET, SUITE 2500, SAN FRANCISCO, CA, 94105, US

(73) Assignee: MICROSOFT CORPORATION, Redmond, WA (US)

(21) Appl. No.: 11/608,445

(22) Filed: Dec. 8, 2006

(51) Int. Cl. H04L 12/66

(52) U.S. Cl. 370/352

(57) ABSTRACT

A call is established between a user at a mobile device and a contact logged into a communication service through a computer application. A user selects a contact through a page displayed on a mobile device. The contact may be an email address, a messaging username, or some other contact other than a phone number. A call registration record with the contact data is generated at a network server. The mobile device places a call to a VoIP system, the VoIP system receives the call, retrieves the call registration record and establishes an audio connection between the cell phone and the computer application through which the contact is logged into the communication service. The audio connection is a hybrid connection consisting of a mobile device voice connection between the caller's cell phone and a gateway system and a VoIP connection between a computer and the gateway system.

### BACKGROUND

Telephones have been used as a medium of communication for over one hundred years. A traditional telephone may be used to establish a voice connection with another telephone over the public switched telephone network (PSTN). The PSTN is a telephone system based on copper wires and other equipment which carry analog and digital voice data. To place a call, a first user engages the phone to get a dial tone and then dials a telephone number. The PSTN then establishes a connection between the first user's telephone and a telephone connected to the PSTN that is associated with the dialed number.

Since the original telephone system, cellular phone technology has emerged to connect people using mobile cellular phones. A connection between two cell phones is made using cell towers that are in range of each cell phone and a cellular phone digital switching system. For example, a cell phone user may enter a phone number into a cell phone. The cell phone may transmit a call request signal. The call request signal is received by a cellular tower in the mobile phone network, digitized, transmitted over the cellular phone digital switching system to a cellular tower near a second cell phone associated with the dialed number, and transmitted by the cell tower to the second cell phone. Once the mobile phone connection is established, digitized voice data may be sent between the cell phones through the cellular towers and cellular phone digital switching system.

Cell phones may also access web pages in a format compatible with cell phone displays. For example, a wireless application protocol (WAP) web page may be accessed and presented to a cell phone user by a cell phone browser application. The WAP web page may show links, text and other basic information. For example, the WAP web page may implement a messaging service, email service or some other service. Data sent between the mobile phone and a WAP web server is transmitted using a protocol and network that differ from the protocol and network used to communicate voice data between cell phones (though some components may be used in both cell phone voice and data networks, such as cellular towers).

Voice connections or calls may also be made between computers using voice over internet protocol (VoIP) technology. VoIP technology allows for a person at one computer to have a conversation with someone at another computer over the Internet. To communicate using a VoIP connection, a first user provides audio input through a microphone connected to their computer, a VoIP application on the computer digitizes the received audio input and sends packets of digital audio data to the recipient computer over the Internet. A VoIP application at the recipient computer receives the digitized audio, converts the digital audio data back into an audio signal and provides the audio signal to the recipient through the recipient computer

Some VoIP services allow a computer to have a dedicated phone number. Thus, a call may be made from a cell phone to a user at a computer through the computer user's account with the VoIP service. To make this connection, the user at the cell phone (or traditional phone) must dial the phone number assigned to the user's account with the VoIP service.

### SUMMARY

The present technology enables a mobile device to make a call to a contact that is logged into a communication service at a computer. The call is made to a computer application through which the contact is logged into the communication service; the call is not made to a phone number associated with the contact. In some embodiments, a first user selects The contact may be an email address, a messaging username, a user handle, a user entry from an enterprise directory or some other contact identifier other than a phone number or other contact (other than a phone number) through a page on a mobile device. In response to selection of the contact, a call registration record containing the contact data is created and saved. The mobile device is then provided with and calls a phone number for a VoIP system. The VoIP system receives the call, retrieves the call registration record, and establishes an audio connection between the cell phone and the contact that is logged into the communication service through the computer application.

The audio connection between the mobile device and the computer application is a hybrid connection comprising a mobile device voice connection and a VoIP connection. The mobile device voice connection is established between the caller's mobile device and a gateway system using one of several available mobile device voice protocols, discussed in more detail below. The VoIP connection is established between a computer application used by the call recipient and the gateway system using the Session Initiation Protocol (SIP) or some other protocol. The gateway system receives communications from each call participant, translates the data to a format suitable for the other connection type, and transmits the translated data to the other call participant.

To establish a voice connection, a mobile device communicates a selection of a contact to a network server. The network server generates a call registration record with the selected contact and provides the mobile device with a VoIP system phone number. The mobile device calls the provided VoIP system phone number and is connected to a Voice to IP System. The Voice to IP system retrieves the call registration record and establishes the IP portion of the call (the connection between the Voice to IP System and the computer application the selected contact is logged into a communication service through).

Some embodiments establish an audio connection between a mobile device and a communication application. A request to establish a call to a first contact is received by a Voice to IP system from a mobile device. A phone number is then provided to the mobile device from the Voice to IP system in response to the request. The mobile device then places a call to the phone number. The call from the mobile device is received and a call invitation is sent to a communication application which is associated with the first contact. An audio connection is then established between the mobile device and the communication application.

Embodiments may also establish an audio connection based on a first request to make a call to an email address. A network server receives a first request to make a call to a first email address. A call registration record is generated for the mobile device and a first phone number is provided to the mobile device. The call registration record includes the first phone number and the first email address. A call is received at the first phone number from the mobile device and the call registration record is retrieved. Next, a call invitation is sent to a computer application used to access an email account associated with the first email address. The audio connection is then established between the mobile device and the computer.

Embodiments also make a call from a mobile device. A first email address is selected from a list of electronic email addresses through an interface provided by a mobile device. A call request is then sent by the mobile device to a web service. The call request includes the first electronic mail address. A call registration response which includes a call invocation is then received by the mobile device. A call is then initiated by the mobile device using the received call invocation.

This summary is provided to introduce a selection of concepts in a simplified form that are further described below in the description. This summary is not intended to identify key features or essential features of the claimed subject matter, nor is it intended to be used as an aid in determining the scope of the claimed subject matter.

### BRIEF DESCRIPTION OF THE DRAWINGS

FIG. 1A is a block diagram of an embodiment of a system for establishing a voice session between a mobile device and a messaging client application.

FIG. 1B is a block diagram of an embodiment of a system for establishing a voice session between a mobile device and a browser-based messaging application.

FIG. 2 is a block diagram of a computing environment for implementing the present technology.

FIG. 3 is a flowchart of an embodiment of a method for establishing an audio connection between a mobile device and a computer.

FIG. 4 is a flowchart of an embodiment of a method for receiving a request from a mobile device by a network server.

FIG. 5 is a flowchart of an embodiment of a method for providing a VoIP phone number to a mobile device.

FIG. 6 is a flowchart of an embodiment of a method for receiving a first call to a VoIP phone number from a mobile device.

FIG. 7 is a flowchart of an embodiment of a process for sending a call invitation to a computer.

FIG. 8 is a flowchart of an embodiment of a process for generating and sending an SIP invite request to a computer.

FIG. 9 is a flowchart of an embodiment of a method for establishing an audio connection between a mobile device and a computer.

FIGS. 10A-B illustrate methods for transmitting audio between a mobile device and a computer.

### DETAILED DESCRIPTION

A call can be placed from a mobile device to a contact that is logged into a communication service at a computer. The call is made to an application through which the contact is logged into the communication service rather than to a phone number. In some embodiments, a first user selects a contact through a page displayed on a mobile device. The page may be a network page retrieved from a server, a contact list accessed locally from the mobile device, or some other page. The contact may be an email address, a messaging username, a user handle, a user entry from an enterprise directory or some other contact identifier other than a phone number. In response to selection of the contact, a call registration record that includes the contact data is created at a remote server and the mobile device places a call to a VoIP system. The VoIP system receives the call, retrieves the call registration record, and establishes an audio connection between the cell phone and the contact that is logged into the communication service through an application at a computer.

The audio connection is a hybrid connection comprising a mobile device voice connection and a VoIP connection. The mobile device voice connection is established between the caller's cell phone and a gateway system using one of several available mobile device voice protocols. The VoIP connection is established between a computer used by the recipient and the gateway system. The gateway system receives communications from each call participant, translates the data to a format suitable for the other connection type, and transmits the translated data to the other call participant. A hybrid data transport system allows a call between a cell phone and a computer wherein a purely VoIP call would require an application to be executed on the mobile device, would require the user of the mobile device to have subscribed to a data plan allowing for a large amount of data to be transferred, and/or would not have enough bandwidth to sustain high quality voice signals.

The IP portion of the audio connection is established in response to establishing a voice connection between the mobile device and a Voice to IP system. To establish the voice connection, a mobile device communicates a selection of a contact to a network server. The network server generates a call registration record with the selected contact and provides the mobile device with a VoIP system phone number. The mobile device calls the provided VoIP system phone number and is connected to a Voice to IP System. The Voice to IP system retrieves the call registration record and establishes the IP portion of the call (the connection from the Voice to IP System to the computer application the selected contact is logged into a communication service through). The phone number called by the mobile device is not derived from the selected contact. Rather, it is a number associated with the Voice to IP system. In some embodiments, the number called by the mobile device is selected based on the mobile device phone number to minimize long distance call charges for the owner of the mobile device.

In some embodiments, initiating a call by selecting a contact from a displayed page rather than by entering a phone number enables a mobile device user to connect with contacts within a communication service, for example an email service such as “MSN Hotmail” or an instant messaging service such as “Windows Messenger” or “MSN Messenger,” all by Microsoft Corporation of Redmond, Wash. The mobile device user may select and place a call to a contact through the application in which the recipient contact is logged into the communication service. Thus, the present technology enables a user of a mobile device such as a cellular phone to establish a voice connection with users of a messaging service or email service. Additionally, a user selects an email address or messaging username to be the recipient of the call. The mobile device user does not select a phone number to call.

The present technology may have features that aren't found in typical VoIP services. For example, the mobile device may display a page which includes a user contacts list for a messaging service or email service. The contact list may indicate whether each contact is currently logged into the service or not using “presence information.” Thus, a user making a call may see whether or not the contact is logged in, and can thus receive the call, before making a call to the contact.

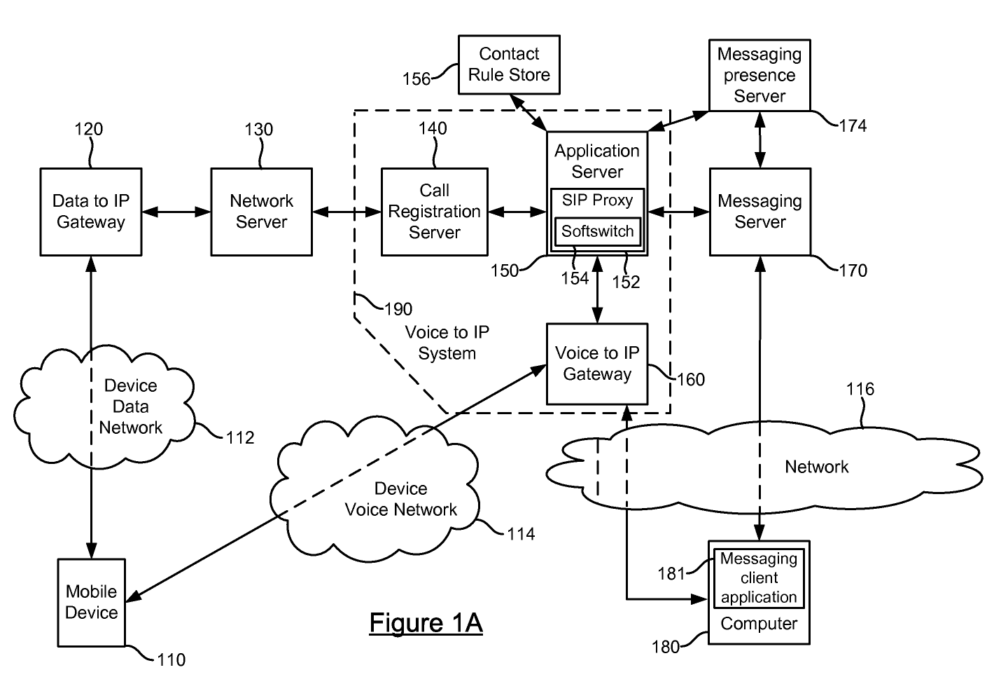

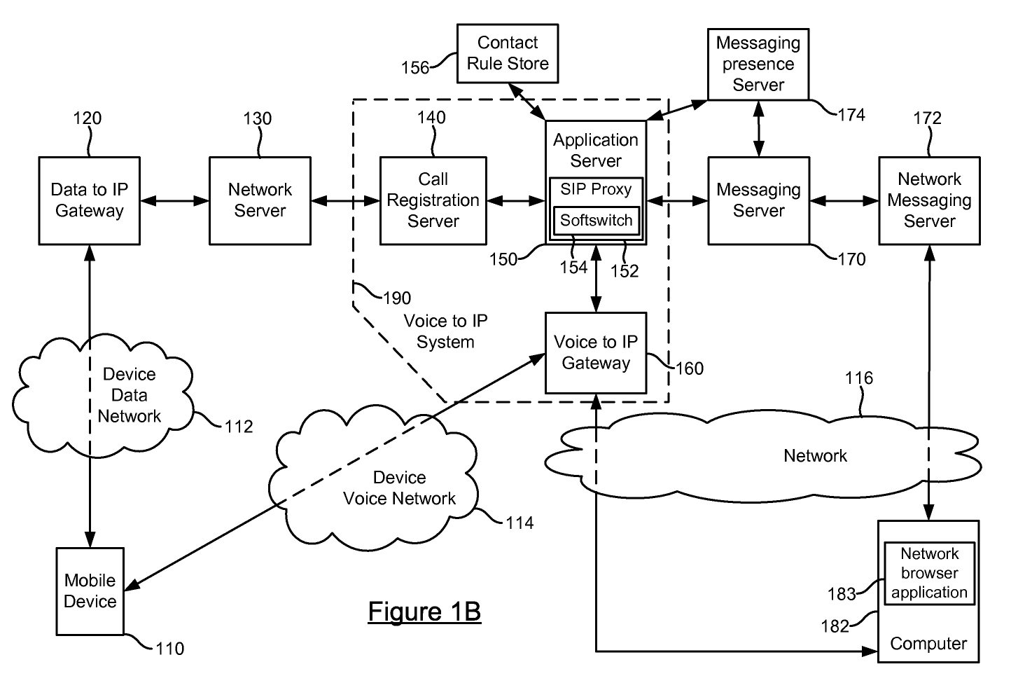

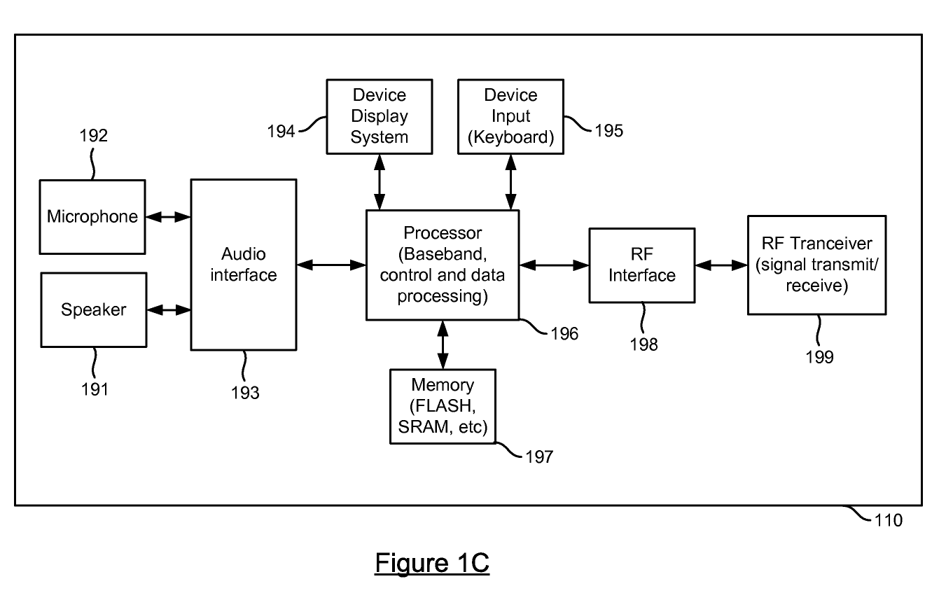

FIG. 1A is a block diagram of an embodiment of a system for establishing an audio connection between a mobile device and a client based messaging system. FIG. 1A includes mobile device 110, Data to IP gateway 120, network server 130, Voice to IP System 190, contact rule store 156, messaging presence server 174, messaging server 170, and computer 180. Voice to IP system 190 includes call registration server 140, application server 150 and voice to IP gateway 160. The system of FIG. 1 also includes Device data network 112, Device voice network 114 and network 116.

Mobile device 110 may be any device able to send and receive digital or analog voice data over Device voice network 114 and send and receive other data (such as contact data network page requests or other non-audio data) over Device data network 112. For example, mobile device 110 may be implemented as a mobile phone, personal digital assistant (PDA), or some other device. In some embodiments, mobile device 110 may send and receive data to network server 130 over Device data network 112 using wireless application protocol (WAP). Mobile device 110 may send and receive voice data with voice to IP gateway 160 over Device voice network 114.

Device voice network 114 may be implemented as a series of cell stations, servers and other machines that may relay and/or encode voice data. In some embodiments, Device voice network 114 may share an infrastructure, such as cell stations or servers, with Device data network 112. Device voice network 114 may also include a public switched telephone network (PSTN).

Device data network 112 may be implemented as a series of cell stations, servers and other machines that may receive mobile device data in WAP format and transmit the WAP data between Data to IP gateway 120 and mobile device 110. Network 116 may be implemented as a public or private intranet or the Internet.

Data to IP gateway 120 may receive data over network 112, convert the received data to a network compatible protocol, such as HTML or XML, and forward the converted data to network server 130. Network server 130 may provide one or more network pages in a format compatible with a mobile device (such as a WAP formatted network page), receive requests from mobile device 110, send responses to mobile device and communicate with call registration server 140. In some embodiments, network server 130 may be implemented as a web server.

Call registration server 140 may generate a call registration record in response to receiving a request from network server 130. A call registration record consists of a caller's phone number and a callee's contact name. The callee's contact name may be implemented as an e-mail address, an instant messaging username, or a user name or user handle for some other service. In some embodiments, the contact information is not a phone number for the call recipient. After generating a call registration record, call registration server 140 can provide a confirmation message to network server 130. The generated call registration record may be accessed by application server 150 and other machines.

Application server 150 may communicate with call registration server 140, contact rule store 156, voice to IP gateway 160, messaging server 170 and messaging presence server 174. Application server 150 may include an SIP proxy 152 and soft switch 154. In some embodiments, application server 150 may include either SIP proxy 152 or soft switch 154. In some embodiments, SIP proxy and soft switch 154 may be used interchangeably. Thus, when one of SIP proxy 152 or soft switch 154 is referenced herein, it is intended that the other could be used as well. Soft switch 154 may process a SIP communication, route requests to one or more messaging servers, forward or receive SIP messages, and perform other functions. Soft switch 154 may initiate retrieving a call registration record from call registration server 140, retrieving user rules from contact rule store 156, retrieving presence information for a contact from messaging presence server 174, receiving voice data and other data from voice to IP gateway 160, and communication of SIP data and other information with messaging server 170.

Voice to IP gateway 160 may be implemented as one or more servers or other devices that communicate with mobile device 110, application server 150 and computer 180. Voice to IP gateway 160 may act as a broker between mobile device 110 and an application that implements instant messaging or e-mail, for example messaging client application 181 on computer 180. Voice to IP gateway 160 may also relay messages and data between soft switch 154 and mobile device 110 as an audio connection or session is being established between mobile device 110 and an application.

Messaging server 170 may be implemented as one or more servers. Messaging server 170 manages messaging between one or more users having an account with a service provided by messaging server 170. Messaging server 170 may handle client login, broker connections between messaging applications, manage presence information and route notification data. Messaging server 170 may communicate with messaging presence server 175, application server 150, one or more messaging client applications such as application 181 on a computer 180, and network messaging server 172.

Messaging presence server 174 may store presence information provided to it by messaging server 170. The presence information stored on messaging presence server 174 may be accessed by other machines, such as application server 150. The presence information indicates whether or not a user having an account with a messaging service provided by messaging server 170 is currently logged into the messaging service. Messaging presence server 174 may be implemented as one or more servers.

Computer 180 includes messaging client application 181. Messaging client application 181 is a standalone program that provides a user interface. The user interface may allow a user to log into and use a messaging service provided by messaging server 170. Messaging client application 181 enables messaging between a user and one or more contacts, correlates data received from messaging server 170 to a particular contact, and provides other messaging functionality.

FIG. 1B is a block diagram of an embodiment of a system for establishing an audio connection between a mobile device and a browser-based messaging application. FIG. 1B includes the elements of the system of FIG. 1A except computer 180 and additionally includes network messaging server 172 and computer 182.

Network messaging server 172 may act as an intermediary between messaging server 170 and browser-based client application 183 on computer 182. Network messaging server 172 may provide a network page to network browser application 183. The network page may include an interface which allows a user of computer 182 to log into and use a messaging service. In some embodiments, when network 116 is implemented as the Internet, network messaging server 172 may be implemented as a web server.

Computer 182 includes network browser application 183. Network browser application 183 renders a network page (such as a web page) provided by network messaging server 172. The network page rendered by network browser application 183 may be used to implement a messaging interface for user login and use of a messaging service provided by messaging server 170.

The technology herein may be discussed below with respect to computer 180 and messaging client application 181. These particular references are intended as examples only. Embodiments of the present technology may use computer 182 and network browser application 183 to perform the functionality discussed below as well as other computers and networking services, such as an e-mail client applications and web based email applications. References to specific computers or computer applications are intended only as an example.

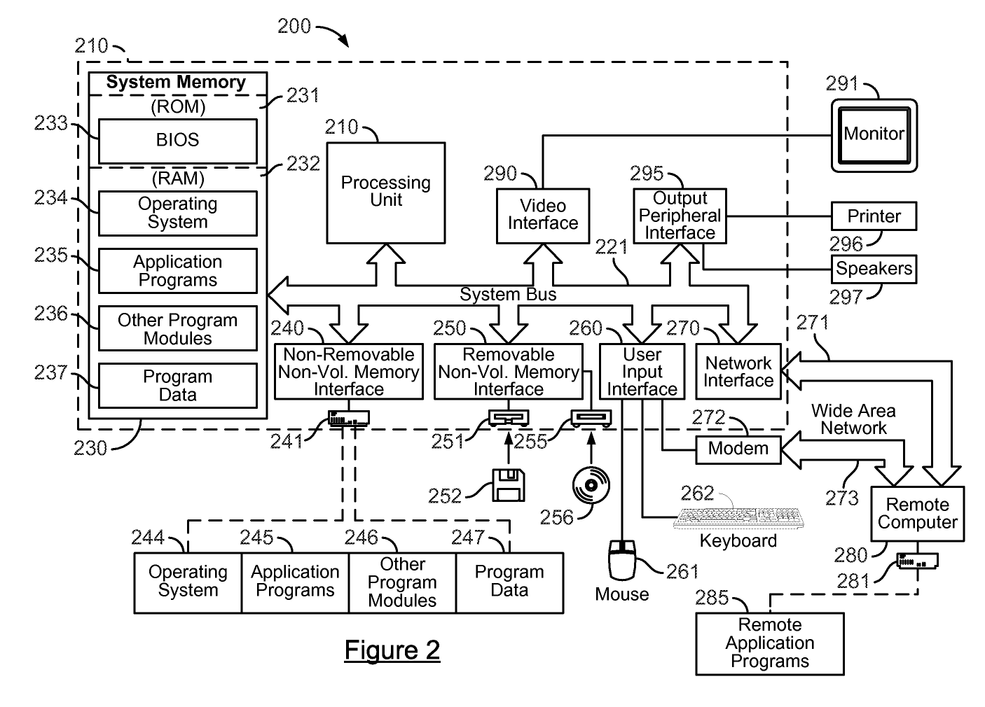

FIG. 2 is a block diagram of a computing environment for implementing the present technology. In some embodiments, the block diagram of FIG. 2 may be used to implement gateway 120, gateway 160, network server 130, call registration server 140, application server 150, contact rule store 156, messaging presence server 174, messaging server 170, network messaging server 172 and computers 180 and 182.

FIG. 2 illustrates an example of a suitable computing system environment 200 on which the present technology may be implemented. The computing system environment 200 is only one example of a suitable computing environment and is not intended to suggest any limitation as to the scope of use or functionality of the technology. Neither should the computing environment 200 be interpreted as having any dependency or requirement relating to any one or combination of components illustrated in the exemplary operating environment 200.

The technology is operational with numerous other general purpose or special purpose computing system environments or configurations. Examples of well known computing systems, environments, and/or configurations that may be suitable for use with the technology include, but are not limited to, personal computers, server computers, hand-held or laptop devices, cell phones, smart phones, multiprocessor systems, microprocessor-based systems, set top boxes, programmable consumer electronics, network PCs, minicomputers, mainframe computers, distributed computing environments that include any of the above systems or devices, and the like.

The technology may be described in the general context of computer-executable instructions, such as program modules, being executed by a computer. Generally, program modules include routines, programs, objects, components, data structures, etc. that perform particular tasks or implement particular abstract data types. The technology may also be practiced in distributed computing environments where tasks are performed by remote processing devices that are linked through a communications network. In a distributed computing environment, program modules may be located in both local and remote computer storage media including memory storage devices.

With reference to FIG. 2, an exemplary system for implementing the technology includes a general purpose computing device in the form of a computer 210. Components of computer 210 may include, but are not limited to, a processing unit 220, a system memory 230, and a system bus 221 that couples various system components including the system memory to the processing unit 220. The system bus 221 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 210 typically includes a variety of computer readable media. Computer readable media can be any available media that can be accessed by computer 210 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 210. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 230 includes computer storage media in the form of volatile and/or nonvolatile memory such as read only memory (ROM) 231 and random access memory (RAM) 232. A basic input/output system 233 (BIOS), containing the basic routines that help to transfer information between elements within computer 210, such as during start-up, is typically stored in ROM 231. RAM 232 typically contains data and/or program modules that are immediately accessible to and/or presently being operated on by processing unit 220. By way of example, and not limitation, FIG. 2 illustrates operating system 234, application programs 235, other program modules 236, and program data 237.

The computer 210 may also include other removable/non-removable, volatile/nonvolatile computer storage media. By way of example only, FIG. 2 illustrates a hard disk drive 240 that reads from or writes to non-removable, nonvolatile magnetic media, a magnetic disk drive 251 that reads from or writes to a removable, nonvolatile magnetic disk 252, and an optical disk drive 255 that reads from or writes to a removable, nonvolatile optical disk 256 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 241 is typically connected to the system bus 221 through a non-removable memory interface such as interface 240, and magnetic disk drive 251 and optical disk drive 255 are typically connected to the system bus 221 by a removable memory interface, such as interface 250.

The drives and their associated computer storage media discussed above and illustrated in FIG. 2, provide storage of computer readable instructions, data structures, program modules and other data for the computer 210. In FIG. 2, for example, hard disk drive 241 is illustrated as storing operating system 244, application programs 245, other program modules 246, and program data 247. Note that these components can either be the same as or different from operating system 234, application programs 235, other program modules 236, and program data 237. Operating system 244, application programs 245, other program modules 246, and program data 247 are given different numbers here to illustrate that, at a minimum, they are different copies. A user may enter commands and information into the computer 20 through input devices such as a keyboard 262 and pointing device 261, commonly referred to as a mouse, trackball or touch pad. Other input devices (not shown) may include a microphone, joystick, game pad, satellite dish, scanner, or the like. These and other input devices are often connected to the processing unit 220 through a user input interface 260 that is coupled to the system bus, but may be connected by other interface and bus structures, such as a parallel port, game port or a universal serial bus (USB). A monitor 291 or other type of display device is also connected to the system bus 221 via an interface, such as a video interface 290. In addition to the monitor, computers may also include other peripheral output devices such as speakers 297 and printer 296, which may be connected through an output peripheral interface 290.

The computer 210 may operate in a networked environment using logical connections to one or more remote computers, such as a remote computer 280. The remote computer 280 may be a personal computer, a server, a router, a network PC, a peer device or other common network node, and typically includes many or all of the elements described above relative to the computer 210, although only a memory storage device 281 has been illustrated in FIG. 2. The logical connections depicted in FIG. 2 include a local area network (LAN) 271 and a wide area network (WAN) 273, but may also include other networks. Such networking environments are commonplace in offices, enterprise-wide computer networks, intranets and the Internet.

When used in a LAN networking environment, the computer 210 is connected to the LAN 271 through a network interface or adapter 270. When used in a WAN networking environment, the computer 210 typically includes a modem 272 or other means for establishing communications over the WAN 273, such as the Internet. The modem 272, which may be internal or external, may be connected to the system bus 221 via the user input interface 260, or other appropriate mechanism. In a networked environment, program modules depicted relative to the computer 210, or portions thereof, may be stored in the remote memory storage device. By way of example, and not limitation, FIG. 2 illustrates remote application programs 285 as residing on memory device 281. It will be appreciated that the network connections shown are exemplary and other means of establishing a communications link between the computers may be used.

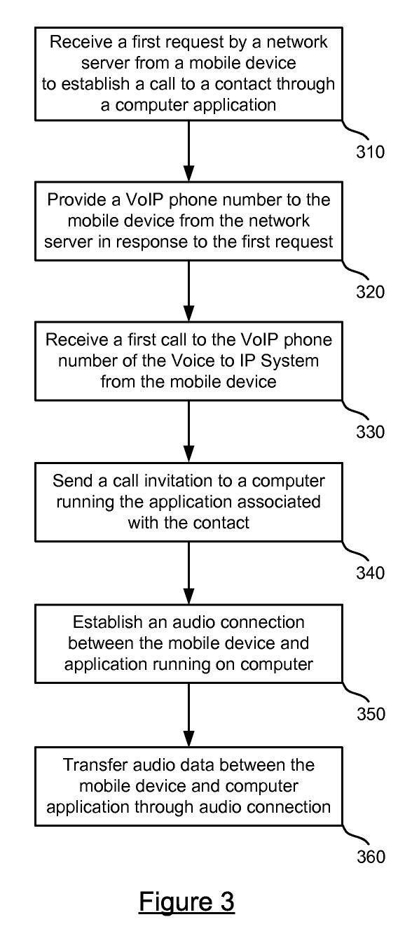

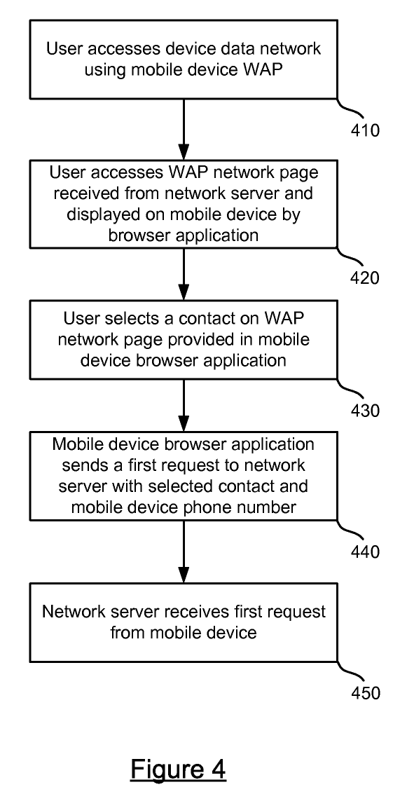

FIG. 3 is a flowchart of an embodiment of a method for establishing an audio connection between mobile device 110 and computer 180. A first request is received by network server 130 from mobile device 110 at step 310. The request is made to establish a call from mobile device 110 to a contact through a computer application. The contact may be associated with a messaging username, an e-mail username, an e-mail address or some other contact information other than a phone number. The request may be made through a network page provided to mobile device 110 by network server 130 through gateway 120 and network 112. Receiving a first request by network server 130 from mobile device 110 to establish a call to a contact through a computer application is discussed in more detail below with respect to the method of FIG. 4.

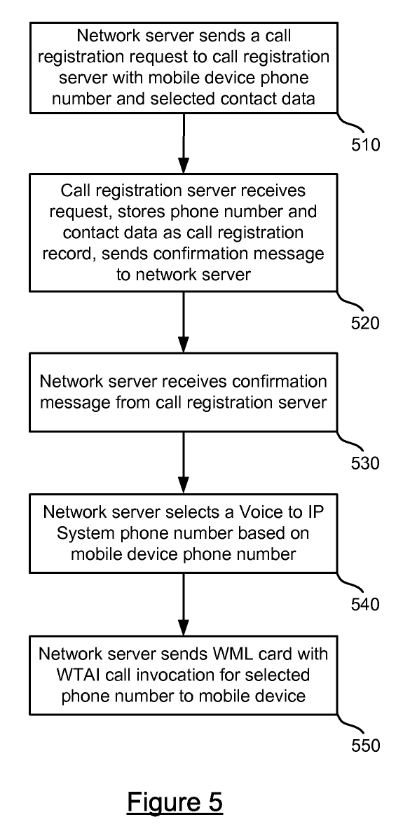

A VoIP phone number is provided to mobile device 110 from network server 130 at step 320. The VoIP phone number may be selected based on the phone number of mobile device 110 and is provided in response to the first request received by network server 130 at step 310. The VoIP phone number may be provided over Device data network 112 in WAP format. Providing a VoIP phone number to mobile device 110 from network server 130 is discussed in more detail below with respect to the method of FIG. 5.

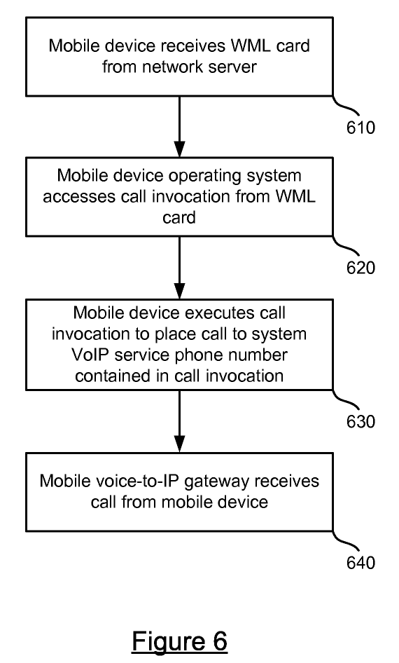

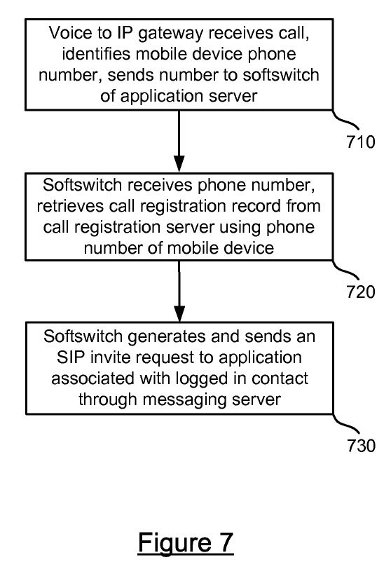

A first call to the VoIP phone number is received by the Voice to IP System from mobile device 110 at step 330. The call is made to the VoIP system phone number provided to mobile device 110 and received over Device voice network 114 by Voice to IP gateway 160. Receiving a first call to the VoIP phone number is described in more detail below with respect to the method of FIG. 6. Next, a call invitation is sent to computer 180 which runs application 181 at step 340. The call invitation is sent by soft switch 154 through SIP proxy 152 to the machine or set of machines where the selected contact is currently logged into a messaging service. Sending a call invitation to computer 180 is discussed in more detail below with respect to the method of FIG. 7.

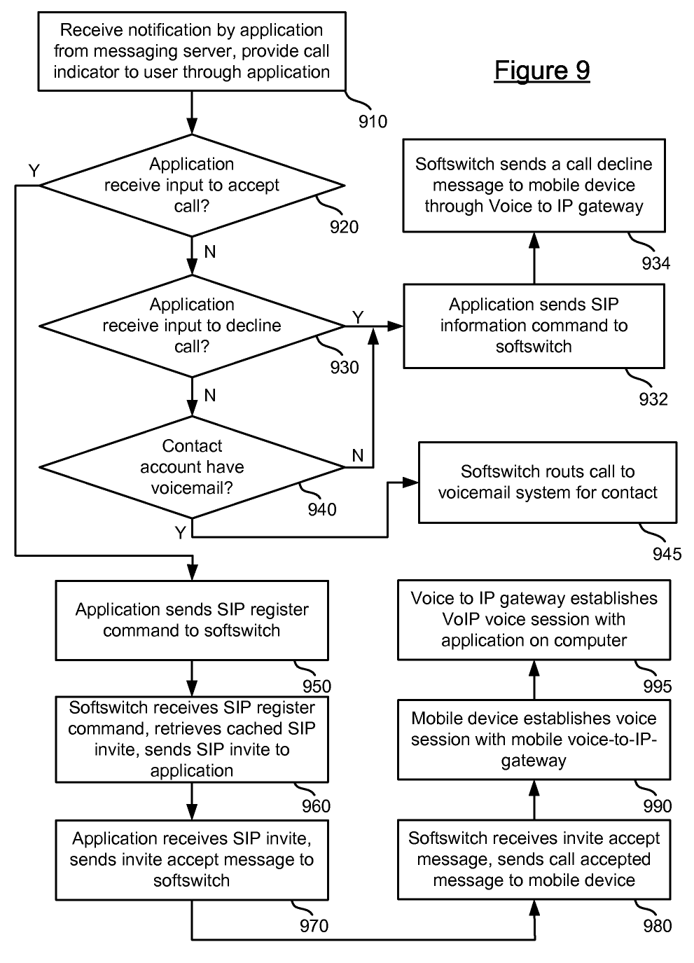

An audio connection is established between mobile device 110 and an application 181 running on computer 180 at step 350. In some embodiments, the audio connection is a hybrid connection. The hybrid connection may consist of a voice connection between mobile device 110 and Voice to IP gateway 160 and a VoIP connection between Voice to IP gateway 160 and computer 180. The voice connection may be established using frequency division multiple access (FDMA), time division multiple access (TDMA), code division multiple access (CDMA), global system for mobile communication (GSM), CDMA 2000, wideband code division multiple access (WCDMA), time division synchronize code division multiple access (TD-SCDMA), or some other voice connection protocol. The VoIP connection may be made using H-323, Session Initiation Protocol (SIP), or some other protocol. Establishing an audio connection between mobile device 110 and an application running on computer 180 is discussed in more detail below with respect to the method of FIG. 9.

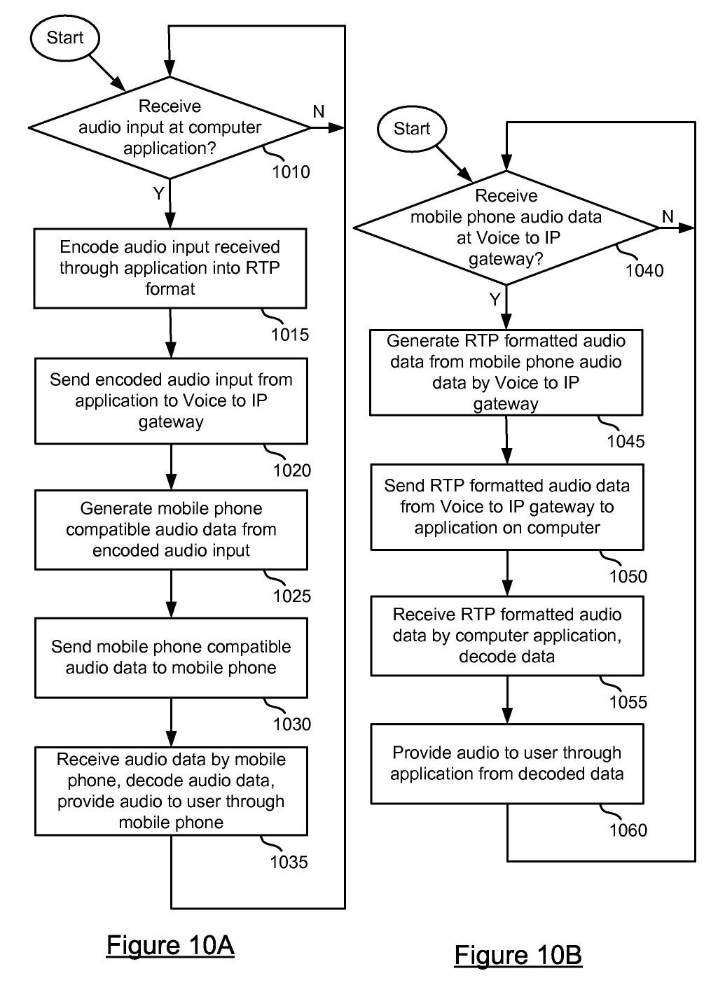

After establishing the audio connection, audio data may be transferred between mobile device 110 and computer application 181 through an audio connection at step 360. This is discussed in more detail below with respect to the methods of FIGS. 10A and 10B.

FIG. 4 is a flowchart of an embodiment of a method for receiving a request from mobile device 110 by network server 130. In one embodiment, the method of FIG. 4 provides more detail for step 310 of FIG. 3. First, a user accesses Device data network 112 using WAP at step 410. This involves establishing a connection to network server 130 by mobile device 110. Once the connection is established, mobile device 110 may request a network page from network server 130.

The user may access a WAP network page received from network server 130 and displayed by a mobile device browser application at step 420. The mobile device browser application may provide the network page to a user through a display of mobile device 110. The network page may include a list of contacts, their presence information, their ability to engage in a VoIP call, and optionally other information. Upon loading the page frame, network server 130 may retrieve and provide the contact list associated with the user of mobile device 110, presence information from presence server 174 associated with each contact on the contact list, and VoIP capability for each online contact from contact rule store 156 (direct and/or indirect connections which can exist between network server 130 and presence server 174 and contact rule store 156 not illustrated in FIGS. 1A-B for simplicity).

A user may select a contact through the WAP network page at step 430. Typically, a contact may be selected by clicking on a link associated with the contact name in the page displayed by mobile device 110. The network page may include a list of e-mail addresses, instant messaging usemames, or other contacts. In some embodiments, the network page may include a field or text box in which a user may enter an e-mail, messaging contact, or other contact data. The contacts displayed in the network page or entered by a user may be associated with a user's e-mail contact list, messaging contacts list (or “friends list”), or other user data.

After selecting a contact or providing contact information into the network page provided by the mobile device browser application, the browser application sends a first request to network server 130 with the selected contact and mobile device 110 phone number at step 440. In some embodiments, the phone number of mobile device 110 may be included as caller identification information in a header of a WAP request sent by mobile device 110 to network server 130. The request from mobile device 110 travels over Device data network 112 to Data to IP gateway 120. Data to IP gateway 120 may then forward the request to network server 130. Network server 130 receives the first request from mobile device 110 at step 450. Processing of the request by network server 130 is discussed in more detail with respect to FIG. 5.

FIG. 5 is a flowchart of an embodiment of a method for providing a VoIP phone number to mobile device 110. In one embodiment, the method of FIG. 5 provides more detail of step 320 of the method of FIG. 3. First, network server 130 sends a call registration request to call registration server 140 at step 510. The call registration request includes the mobile device phone number and the selected contact data provided in the request received from mobile device 110. In one embodiment, the call registration request is a just-in-time call registration.

Call registration server 140 receives the request and processes the request at step 520. Processing the request may include storing the mobile device phone number and contact data contained in the request as a call registration record and sending a confirmation message to network server 130. In some embodiments, the call registration record may expire soon after creation, for example in sixty seconds or some other time period. In some embodiments, call registration server 140 may store additional data as part of the call registration record. The additional data may provide a rich call experience for the recipient of the phone call. For example, the call registration record may include a caller's name, a caller presence I.D., and other information. In some embodiments, the additional information contained in a call registration record may be obtained from the request made by mobile device 110 or may be retrieved from a request to contact rule store 156. This is discussed in more detail below.

Network server 130 receives the confirmation message from call registration server 140 at step 530. Next, network server 130 selects a phone number associated with Voice to IP system 190 that is based on the mobile device phone number at step 540. In some embodiments, network server 130 selects a Voice to IP system phone number which is close in geographic vicinity to the phone number associated with mobile device 110. A Voice to IP system phone number that is close geographically to mobile device 110 may reduce the costs associated with a call between mobile device and the particular selected phone number. For example, the selected VoIP phone number may have the same area code as the mobile device phone number.

After selecting a Voice to IP system phone number, network server 130 sends a wireless markup language (WML) card with the selected phone number to mobile device 110 at step 550. In some embodiments, network server 130 may send the WML card with a wireless telephony application interface (WTAI) call invocation for the selected VoIP phone number to mobile device 110. In some embodiments, the call invocation within the WTAI call invocation includes script code that provides an instruction to call the selected Voice to IP system phone number.

FIG. 6 is a flowchart of an embodiment of a method for receiving a first call to a VoIP phone number from mobile device 110. In some embodiments, the method of FIG. 6 provides more detail for step 330 of the method of FIG. 3. Mobile device 110 receives the WML card from network server 130 at step 610. The WML card may be received by mobile device 110 over Device data network 112. Next, the browser or operating system of mobile device 110 may access the call invocation from the WML card at step 620.

Mobile device 110 then executes a call invocation at step 630. The call invocation places a call to the selected Voice to IP system phone number contained in the call invocation. In one embodiment, the mobile device 110 executes script code in the WTAI call invocation to place a call to the phone number contained in the WAP card. The call may be made from mobile device 110 over Device voice network 114. Voice to IP gateway 160 receives the call from mobile device 110 at step 640. Processing of the call is discussed with respect to FIG. 7.

FIG. 7 is a flowchart of an embodiment of a method for sending a call invitation to a computer. In some embodiments, the method of FIG. 7 provides more detail for step 340 of the method of FIG. 3. First, Voice to IP gateway 160 receives a call and identifies the phone number at step 710. The phone number at which the call is received (e.g., the number called by mobile device 110) is a Voice to IP system phone number. Once the phone call is received by the Voice to IP system, the call is forwarded to soft switch 154 of application 150. In one embodiment, Voice to IP gateway 160 determines the number called as a system VoIP service number and therefore routes the call to soft switch 154 of application server 150. In some embodiments, rather than forwarding the call, gateway 160 provides a message to soft switch 154 indicating that a call to the particular number from the particular source mobile device phone number is received.

Soft switch 154 receives the call from the mobile device phone number and retrieves the call registration record associated with the number at step 720. Soft switch 154 retrieves the call registration record from call registration server 140. In some embodiments, soft switch 154 sends a request which includes the phone number of mobile device 110 for the call registration record to call registration server 140. Call registration server 140 receives the request, looks up the phone number either locally or remotely where call registration records are stored, retrieves the call registration record associated with the number in the request, and sends the call registration record to soft switch 154. In some embodiments, the call registration record is discarded or expires from the call registration server (or wherever the call registration record is stored) after the record is retrieved, or after a fixed time interval.

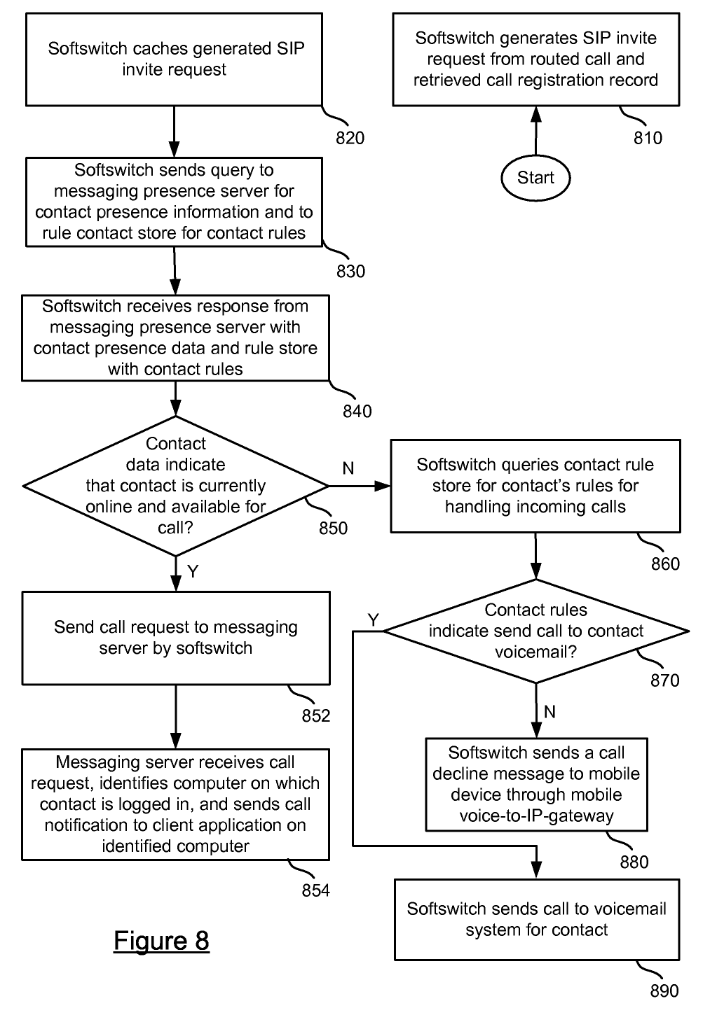

Soft switch 154 generates and sends an SIP invite request to application 180 at step 730. The application is associated with a contact that is logged into messaging server 170. Generating and sending an SIP invite request to an application is discussed in more detail with respect to FIG. 8.

FIG. 8 is a flowchart of an embodiment of a process for generating and sending an SIP invite request to a computer. In one embodiment, the method of FIG. 8 provides more detail for step 730 of the method of FIG. 7. First, soft switch 154 generates an SIP invite request from the received call and retrieved call registration record at step 810. In some embodiments, soft switch 154 may receive an SIP invite from gateway 160. In this embodiment, gateway 160 may generate the SIP invite and forward the invite to soft switch 154.

Soft switch 154 caches the generated SIP invite request at step 820. The SIP invite request is cached while soft switch 154 determines if the intended recipient will accept the phone call. Soft switch 154 sends a query to messaging presence server 174 for contact presence information and to contact rule store 156 for rules associated with the contact at step 830. The data received from contact rule store 156 may be used to determine is contained in the callee's block list and the call should not be accepted, if the call should be forwarded to a different number, or the call should otherwise be processed. Soft switch 154 sends the query with respect to the email address, messaging username or other contact information contained in the call registration record retrieved from call registration server 140 at step 720 of FIG. 7. Thus, soft switch 154 determines whether the recipient contact is logged into messaging server 170 and available to accept the call. In some embodiments, once messaging presence server 174 receives the request, the server will look to see if the contact name is a proper contact and whether the contact is currently online or not. Messaging presence server 174 then sends a response to soft switch 154 with presence data for the particular contact.

Soft switch 154 receives a response from messaging presence server 174 with the contact presence data at step 840. Next, soft switch 154 makes a determination as to whether the contact data for the selected contact indicates that the contact is currently online or not at step 850. If the contact is determined to be online, the method of FIG. 8 continues to step 852. If the contact is not online, soft switch 154 queries contact rule store 156 for the contact's rules for handling incoming calls at step 860. Querying a contact rule store 156 may include soft switch 154 sending a query for call handling rules for the selected contact, contact rule store 156 receiving the request and retrieving rules associated with the particular contact, packaging the rules in a response and sending the response to soft switch 154. A contact's rules for handling incoming calls may specify rules for voicemail, call forwarding, call blocking and other rules for handling incoming calls.

Next, soft switch 154 determines if the contact rules indicate that the call should be sent to voicemail at step 870. If the call should be sent to voicemail, soft switch 154 sends the call to a voicemail system for the contact at step 890. If the contact rules do not indicate the call should be sent to voicemail, soft switch 154 sends a call decline message to mobile device 110 through Voice to IP gateway 160 and Device voice network 114. In some embodiments, if the contact rules indicate the call should not be sent to voicemail, additional inquiries can be made as to whether the call should be forwarded or the call should be blocked. The call is then handled according to the particular rules.

If the contact presence data indicates that the contact is currently online and the call may be forwarded after applying rules retrieved from contact rule store 156, a call request is sent to messaging server 170 by soft switch 154 at step 852. Messaging server 170 receives the call request and forwards the request to client messaging application 181 at step 854. Upon receiving the request, messaging server 170 identifies computer 180 at which the contact is logged in and sends a call notification to client application 181 on computer 180. Identifying the computer at which the contact is logged in may be done by messaging server 170 locally or by querying another messaging server (not illustrated).

FIG. 9 is a flowchart of an embodiment of a method for establishing an audio connection between a mobile device and a computer. In some embodiments, the method of FIG. 9 provides more detail of step 350 of the method of FIG. 3. First, an incoming call notification is received by client application 181 from messenger server 170 at step 910. Upon receiving the notification from messaging server 170, messaging client application 181 may provide one or more call indicators to a user through an interface provided by client application 181. The indicators may include a popup window indicating that a call is requested with the user, a “toast” indicator querying if the user would like to accept a call, or some other indicator. In some embodiments, the indicator may include a selectable GUI button or other element allowing a user to indicate whether to accept or deny the incoming call.

A determination is made as to whether messaging client application 181 receives input to accept the call at step 920. In one embodiment, the input is received from the user through an interface provided by messaging client application 181. If application 181 determines that input has been received to accept the call, the method of FIG. 9 continues to step 950. If client application 181 does not receive input to accept the call, a determination is made by application 181 as to whether or not input has been received to decline the call at step 930. If input has been received to decline the call, application 181 sends an SIP information command to soft switch 154. The SIP information command includes information which indicates that the request has been denied. Next, soft switch 154 will send a call decline message to mobile device 110 through voice to IP gateway 160. If the application did not receive input to decline the call at step 930, a determination is made by application 181 as to whether the contact account has voicemail at step 940. The determination may be the same determination made at step 870 by soft switch 154. In some embodiments, the determination at 940 is made by soft switch 154. If the contact account does not have voicemail, application 181 may send an SIP information command to soft switch 154 at step 932 and the process then ends at step 934. If the contact account does have voicemail, soft switch 154 may route the call to a voicemail system for the contact at step 945.

Upon receiving input to accept the call, application 181 sends an SIP register command to soft switch 154 at step 950. The command may be sent by application 181 to messaging server 170 which then forwards the register command to soft switch 154. Soft switch 154 receives the SIP register command, retrieves the cached SIP invite, and sends the SIP invite to application 181 at step 960. The cached SIP invite includes information which enables application 181 to establish a VoIP connection to voice to IP gateway 160.

Application 181 receives the SIP invite from soft switch 154 and sends an invite accept message to soft switch 154 at step 970. Soft switch 154 receives the invite accept message from application 181 and sends a call accepted message to mobile device 110 at step 980. The call accepted message is sent from soft switch 154 to gateway 160. Gateway 160 then generates a proper formatted call accept message over Device voice network 114 to mobile device 110. Mobile device 110 then establishes a voice session with Voice to IP gateway 160 at step 990. Voice to IP gateway 160 then establishes a VoIP voice session with messaging client application 180 at step 995. Steps 990 and 995 thus complete generation of the hybrid communication session between mobile device 110 and messaging client application 181 on computer 180.

In some embodiments, a call may be handled in another way than that described in FIG. 9. The incoming call notification may be received by a client application. The client application may then register with the soft switch, and the soft switch may then forward an SIP Invite to the client application. The client application may then provide a user interface to a user. The user may provide input through the interface, or in some other manner, to choose whether to accept or decline the call. Once input is receive regarding how the user wishes to handle the call (accept, decline) or a timeout expires, a SIP response message with an appropriate response code (e.g., 408 Request Timeout for timeout, or 200 OK for accept) can be sent to the soft switch.

FIGS. 10A-B illustrate methods for transmitting audio between a mobile device and a computer. In some embodiments, FIGS. 10A-10B provide more detail for step 360 of the method of FIG. 3. In particular, FIG. 10A illustrates how data is sent from application 181 to mobile device 110 over Voice to IP gateway 160 and FIG. 10B describes a method for providing data from mobile device 110 over an audio connection to messaging client application 181. The methods illustrated in FIG. 10A and 10B may be implemented independently of each other. First, FIG. 10A shall be discussed. First, a determination is made as to whether audio input is received at application 181 at step 1010. If no input is received, no data is sent from application 181 to voice to IP gateway 160. If audio input is received at application 181, the received audio input is encoded into an RTP format at step 1015. RTP protocol is a protocol for transmitting real-time audio data between applications. Next, the encoded audio input is sent from application 181 to Voice to IP gateway 160 at step 1020. Mobile device voice data is then generated from the encoded audio input at step 1025 by voice to IP gateway 160. The mobile device voice data may be in TDMA, CDMA, GSM or some other mobile device audio format. The mobile phone compatible audio data is then sent by Voice to IP gateway 160 to mobile device 110 over Device voice network 114. The audio data is received by mobile device 110, decoded as needed, and audio derived from the received audio data is provided to a user by mobile device 110 at step 1035. The method of FIG. 10A then returns to step 1010.

FIG. 10B describes a method for providing data from mobile device 110 over an audio connection to messaging client application 181. First, a determination is made by mobile device 110 as to whether mobile phone audio data is received at voice to IP gateway 160. The mobile phone audio data is generated by mobile device 110 in response to a user talking into mobile device 110. If no audio data is received by gateway 160 at step 1040, the method of FIG. 10B remains at step 1040 until audio data is received. If audio data is received by voice to IP gateway 160, RTP formatted audio data is generated from the mobile phone audio data by Voice to IP gateway 160 at step 1045. The audio data is then sent from Voice to IP gateway 160 to messaging client application 181 at step 1050. Next, messaging client application 181 receives the RTP formatted audio data and decodes the data at step 1055. The decoded data is then provided as audio through messaging client application 181 at computer 180 at step 1060. The method of FIG. 10B then returns to step 1040.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims appended hereto.

We claim:

1. A method for establishing an audio connection, comprising:
receiving a first request to establish a call to a first contact, the first request received from a mobile device associated with a first phone number;
providing a second phone number to the mobile device in response to said step of receiving the first request;
receiving a first call to the second phone number from the mobile device;
sending a call invitation to a communication application associated with the first contact in response to the first call; and
establishing an audio connection between the mobile device and the communication application.

2. The method of claim 1, wherein said step of receiving includes:
receiving the first request at a network server, wherein the second phone number is provided to the mobile device by the network server.

3. The method of claim 1, wherein the contact is one of a group consisting of an instant messaging username, a user handle, a user entry from an enterprise directory or an electronic mail address.

4. The method of claim 1, further comprising:
generating a record containing first contact data in response to said step of receiving the first request

5. The method of claim 4, wherein said step of generating a record includes:
generating a call registration record for the first phone number, the call registration record including the first phone number and the first contact; and
providing a second phone number to the mobile device in response to said step of generating a call registration record.

6. The method of 1, wherein said step of sending a call invitation includes:
retrieving a call registration record that includes the first contact; and
sending a message to a computer application associated with the first contact.

7. The method of 1, further comprising:
determining a location of a computer on which the contact is currently logged into a communication service; and
sending the message to the location on which the contact is currently logged in.

8. The method of 1, wherein said step of establishing an audio connection includes:
establishing a mobile device voice connection from a mobile device to a gateway system;
establishing an audio data connection over an Internet protocol (IP) connection; and
sending audio data between two call participants over the mobile device voice connection and Internet protocol connection.

9. The method of 1, wherein said step of sending a call invitation includes:
determining if the contact is currently logged into a communication service associated through the communication application.

10. The method of claim 1, wherein said step of sending a call invitation includes:
sending a call request to messaging server; and
receiving a response from the messaging server indicating the contact accepts the call.

11. A method for establishing an audio connection, comprising:
receiving a first request at a network server to make a call to a first contact, the first request received from a mobile device associated with a first phone number;
generating a call registration record for the first phone number, the call registration record including the first phone number and the first contact;
providing a second phone number to the mobile device in response to said step of generating the call registration record;
receiving a first call to the second phone number from the mobile device;
retrieving the call registration record in response to receiving the first call;
sending a call invitation to an application on a computer, the application used to access an account associated with the first contact; and
establishing an audio connection between the mobile device and the computer.

12. The method of claim 11, wherein the second phone number is derived from geographic information associated with the first phone number.

13. The method of claim 11, wherein said step of sending a call invitation includes:
determining a presence information for the first contact.

14. The method of claim 11, wherein said step of establishing an audio connection includes:
receiving a response to the call invitation;
establishing a mobile device voice connection between the mobile device and a gateway system; and
establishing an IP communication session between the computer application and the gateway system.

15. The method of claim 11, wherein said step of sending a call invitation includes:
accessing a call block list associated with the first contact.

16. The method of claim 11, wherein said step of sending a call invitation includes:
sending a call invitation to a contact through a browser application.

17. A method for making a call from a mobile device, comprising:
receiving a selection of a first contact from a list of electronic mail addresses through an interface provided by a mobile device;
sending a call request to a web service by the mobile device, the call request including the first contact and sent in response to said step of receiving a selection of the first contact;
receiving a call response from the web service, the call response including a call invocation; and
initiating a call by the mobile device using the received call invocation.

18. The method of claim 17, wherein the call invocation includes script code with instructions to place a call to a first phone number.

19. The method of claim 17, further comprising:
providing a list of emails for each of one or more contacts that are logged into an email service, the first electronic email included in the list of emails.

20. The method of claim 17, further comprising:
determining presence information for a contact.
